(19) United States
(12) Patent Application Publication
(10) Pub. No.: US 2025/0042735 A1
(43) Pub. Date: Feb. 6, 2025

(54) DEVICE FOR THE PRODUCTION OF HYDROGEN AND CO2 FROM SUPPLIED HYDROCARBON AND WATER

(71) Applicant: Hyper Energy Australia Pty Ltd, Darlinghurst (AU)

(72) Inventor: Åge SKOMSVOLD, Tønsberg (NO)

(73) Assignee: Hyper Energy Australia Pty Ltd, Darlinghurst (AU)

(21) Appl. No.: 18/716,431

(22) PCT Filed: Dec. 7, 2022
(86) PCT No.: PCT/NO2022/050284

§ 371 Date: Jun. 4, 2024

(30) Foreign Application Priority Data
Dec. 8, 2021 (NO) 20211480

(51) Int. Cl. C01B 3/38; B01D 53/00; B01J 19/00; B01J 19/24; C01B 3/48; C01B 3/50

(52) U.S. Cl. CPC C01B 3/382; B01D 53/002; B01J 19/0013; B01J 19/249; C01B 3/48; C01B 3/506; B01D 2256/16; B01D 2257/504; B01D 2257/80; B01J 2219/00092; B01J 2219/00103; B01J 2219/00108; B01J 2219/30219; C01B 2203/0233; C01B 2203/0283; C01B 2203/046; C01B 2203/0475; C01B 2203/0495; C01B 2203/0833; C01B 2203/1241

(57) ABSTRACT

The present disclosure relates to a device adapted to produce H₂ and CO₂ from supplied Hydrocarbon and water under high pressure.

### INVENTION AREA

The following invention relates to a device for producing Hydrogen (H₂) and Carbon Dioxide (CO₂) by splitting/reforming added Hydrocarbon and water.

### TECHNICAL BACKGROUND

Hydrocarbon (HC) is a bond with a number of Carbon and Hydrogen atoms (CₘHₙ) that can be in the form of gas or liquid and can, for example, be Methane (CH₄).

Current methods and devices for producing the production of Hydrogen and CO₂ from the inlet fluids HC and water via a heated and catalytic process are mainly done today with Methane and a Steam Methane Reforming (SMR) catalytic reactor, which produces Syngas containing H₂, CO and some CO₂ which together with water vapor is led to a Water Gas Shift (WGS) catalytic reactor that converts water and CO into more H₂ and CO₂, which together with small residues of water are the main products of WGS at favorable conversion. The mixture is then directed to a gas separator (SEP), where residual steam can be condensed before H₂ and CO₂ are separated from each other through SEP, which today usually uses a Pressure Swing Adsorption (PSA) system and/or with Amine fluids. Furthermore, CO₂ and H₂ will each be compressed, where CO₂ is utilized or stored (CCUS) and H₂ can be further high-pressure compressed or liquefied for better handling before utilization.

The challenge with today's SMR plants is that they require a lot of supplied heat energy as it is endothermic, some of this heat comes from WGS which is exothermic, in total this gives a theoretical heat input energy of 17.5% of the produced Hydrogen, when Methane gas is used. In practice, up to 50% of heat is supplied with energy, often by combustion of some of the added Methane. The large loss is mainly due to heat radiation due to the fact that the plants must be large so that the flow usually does not exceed 25 cm per second to avoid cooling in SMRs that is highly endothermic and do not have time to supply sufficient heat energy. This also results in temperature fluctuations that break down catalysts under operation and must be replaced at least every 2 years. In addition, the exhaust from combustion will both cause heat loss and contain significant greenhouse gases such as CO₂ and unburned Methane, which is 25 times more climate-negative than CO₂. CO₂ capture from exhaust gases is far more energy-intensive due to large amounts of nitrogen (N) from supplied air.

To separate H₂ and CO₂, today's separation plants are large and cost up to 50% of a complete SMR plant and are also very energy-intensive during operation.

Initially, it would be beneficial to increase the pressure in the plant and add more water than is consumed in the splitting. This would have resulted in a beneficially reduced partial pressure for Methane, and the water vapor could also act as a heat carrier directly to the process in the SMR and direct heat carrier from the process in WGS which would allow a faster flow, temperature stability, improved reaction, with a potential for significantly smaller and more efficient facilities, as well as the discharge gases can be delivered to higher pressures when extra water vapor is condensed. However, today's static plants are unable to recycle sufficient heat from extra supplied water and are therefore uneconomical, also because higher pressure entails higher material costs. Some or all heat input could have been supplied via a heat pump (HP) and its cold side could have collected the heat from the products and resulted in less heat loss, and HP's cold side could separate the discharge gases by liquefying at least CO₂, but in today's static plants it would require large HP plants with a lot of large compressors, turbines and heat exchangers to achieve high and low temperatures that are uneconomical with today's static HP.

### SUMMARY OF THE INVENTION

The purpose of the present invention is to produce a compact and economical device for the production of Hydrogen and CO₂ adapted for high temperature and pressure. The device is arranged rotatable, with added Hydrocarbon and water for the production of Hydrogen and CO₂ that is liquefied before discharge, the device of which includes any form of evaporator, SMR, WGS, SEP and HP adapted for rotation with fluid channels to and from, that under constant rotation and high G, HP will provide the necessary heat to the SMR which it partially obtains from the products after the SMR, from the WGS, SEP and from the ambient outside the device, whereupon the HP gas is compressed first with HP's compressor and mostly from the centrifugal force (G) which affects the HP gas so that it becomes hotter outwards in its channel to an evaporator at the periphery where heat indirectly converts added and recycled extra water to dry water vapor along with added and heated Hydrocarbon, after which they are directed into the SMR within, where HP heavy gas after giving the heat to evaporate and then is directed inward and becomes immediately colder and colder from the decompression inwards, while effectively retrieving indirect heat and cooling the products. The high G improves significant mass transport and contact between the fluids and the rotary device's SMR, WGS, SEP and heat exchangers and makes it significantly more efficient and compact compared to today's static plants.

This is achieved by a device according to the attached descriptions and patent claims.

### BRIEF DESCRIPTION OF DRAWINGS

The invention will now be described in detail with reference to the attached FIGURE, where additional properties and advantages of the invention are shown in the subsequent detailed description.

FIG. 1 depicts a principle embodiment of the invention, in which an incision along the axis of rotation and one half of the rotational device is shown; the other half is a mirror image of the half structure that appears along one side of the longitudinal axis of rotation and shows a bearing-supported and rotatable rotation device with inlets, outlets, channels and contains a variety of heat exchangers, evaporators, SMR, WGS, SEP and HP with fluids in the supply and reaction channels, which together form a balanced cylindrical shape around the rotation axis. Downward arrows in the FIGURE symbolize fluid in its channels outward toward the periphery which is compressed by increasing G and arrows up in the FIGURE symbolize fluid in its channels inward which is decompressed towards the axis of rotation by decreasing G.

### DETAILED DESCRIPTION OF THE INVENTION

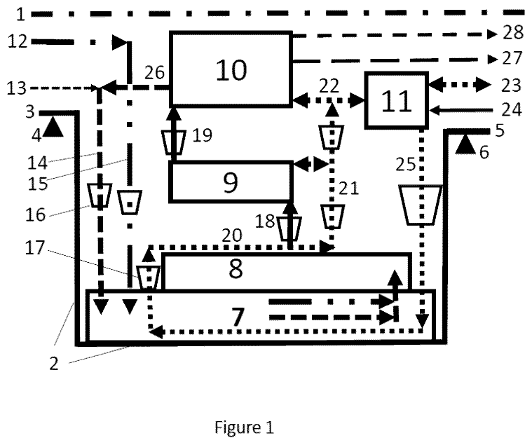

FIG. 1 and according to brief description of the FIGURE, a longitudinal section is shown along the axis of rotation 1 its one side to the rotating device 2 with a cylindrical shape and an inlet side with a hollow inlet shaft 3 supported with inlet bearing 4 and likewise on the outlet side's hollow outlet shaft 5 with outlet bearing 6 making the rotating device 2 rotatable. It contains and supports from the periphery an evaporator 7, SMR 8, WGS 9 and Heat Pump HP 11, where at the inlet side inside the hollow inlet shaft 3 is arranged a Hydrocarbon (HC) inlet channel 12 in a axial tube around the axis of rotation 1 attached with means that seal inside the rotating device 2 against the inner end of the pipe and connect further to several radial HC channels 15 that branch outwards and into one axial side of evaporator 7 to which HC is directed. Evaporator 7's shape is like a hollow cylinder supported along the inner side to the periphery of the rotating device 2 peripheral tubes. Water inlet channel 13 for process water for splitting is led in the room in axial pipe around HC inlet channel 12 and fixed with means that seal inside the rotating device 2 towards the inner end of the pipe's outer side, axially outside the inner end to HC inlet channel 12 and further connects with return water channel 26 where they overall branches outwards inside several radial water channels 14 and into evaporator 7 where the water is directed to the same end as the HC fluid is directed in. In the FIGURE, both radial HC channels 15 and radial water channels 14 are shown with compression 16 symbol on arrows/fluid channels outward by increasing centrifugal force that compresses and the gas becomes hotter. This applies to all radial channels outward. In evaporator 7, HC is mixed with the water where both can be in the form of gas or liquid and which by means of heat from HP 11 and heat fluid channel 25 is heated indirectly from the periphery to a dry gas mixture with adapted heat and extra water vapor for heat transfer and which is led in several channels/holes inward to SMR 8's one end at its outer periphery, where it is located towards the inner periphery of evaporator 7 that also provides additional heat inward and along through the outer periphery into SMR 8 for a stable temperature in it. As under the endothermic catalytic splitting of the gas mixture in which is converted into Syngas (Hydrogen, CO and some CO₂) and with extra water vapor that is not consumed, they are led through the SMR 8 and out to its other end at the inner periphery, where the Syngas provides indirect heat to the HP 11 coolant in the SMR heat exchanger 20 which after evaporates 7 is cooled inward by lower pressure and is symbolized in the FIGURE with expansion symbol on cooling fluid channel 17. This is the same for all the other inward channels 18, 19 and 21 with different fluids. The syngas and extra water vapor will after emitting heat to the cooling fluid in the SMR heat exchanger 20 be transported further in into several SMR syngas channels 18 branching inwards into WGS 9's one end containing adapted catalysts as in an exothermic/emitting heat process converts residues of CO and water vapor into more H₂ and CO₂ which are the end products along with extra water vapor and they are transported inwards in several WGS syngas channels 19 which branches inward into an axial end of SEP (separator) 10, where supplied refrigerant from cooling fluid channel 21 is first directed in to SEP 10 and collects heat to HP 11 via the cooling fluid's SEP cooling channel 22 shown with double arrow in/out connected to cooling fluid channel 21 from the periphery illustrating cold in to SEP 10 and heat out from it and to HP 11. The cooling of the products in SEP 10 will first condense all of the extra water vapor into liquid water, which is diverted for recycling via the return water channel 26. When the water vapor condenses, the partial pressure increases significantly on the residual gas and the CO₂ condenses and becomes liquid, which with further cooling liquefies virtually all the CO₂ that is discharged pressurized via CO₂ outlet channel 27, which can be the same as described for water inlet channel 13. The last gas in separator SEP 10 after a series of heat exchangers inwards, the H₂ is thus relatively clean and cold which is discharged under high pressure via the H₂ outlet channel 28, which may be the same as described for the HC inlet channel 12. All heat will be rapidly transferred inwards into the fluids with high convection in the high G. This will provide good and fast contact between fluids and heat exchangers that in high-G transport the heat rapidly inwards and cold rapidly outwards and then in reactors with catalysts as in SMR 8 and WGS 9 where the mass transport is high and with extra water vapor it maintains a relatively stable temperature in the reactions, which can thus be implemented as quickly as possible and at the same time increase the conversion of the inlet products to SMR 8 and WGS 9 to new products inwards towards the SEP 10. During high G, heat has difficulty moving outward in the fluid and will thus act as an insulator and this can be exploited in the rotation device where desired, for example, a colder fluid outside evaporator 7 in a hollow cylindrical form where the fluid flows laminar through of the heat within in the high G and this will keep the outer peripheral tube relatively cold and maintain its strength for support.

As shown in FIG. 1, the rotating device 2 and its contents 7, 8, 9, 10, 11 and heat exchangers (not shown) may be arranged with axial tubes of different dimensions, materials and radius within or after each other in some cases. The tubes enclose and are centered around axis of rotation 1 and that tubes within will then almost float on fluids outside and pipes inside the rotor can thus be relatively thin and improve heat exchanges where needed. The outermost, largest and most massive pipe will be the periphery of the rotating device 2 and can be the periphery of heating fluid in evaporator 7. The next pipe inward is the heat exchange tube between the heating fluid and evaporator 7 where the mixture of supplied water and Hydrocarbon is heated to a hot dry gas which is held in place by the next heat exchange pipe within which it also gives off heat and which is also the outer periphery tube to SMR 8 which forms the space with next tube in its inner radius.

The gas mixture from evaporator 7 is led in several channels/holes into the SMR 8 room's one end at its periphery. The SMR contains catalysts that convert some of the water steam and HC to H₂, CO and some CO₂. The axial tube within SMR 8 can be temperature insulated and within this tube can be arranged an SMR heat exchanger 20 arranged with two hollow cylindrical compartments with a heat exchanger tube between them, where in the outermost cavity it forms a axial hot fluid syngas channel from SMR 8's other end at the inner periphery via multiple channels/holes into the syngas channel of the SMR heat exchanger 20 and where the innermost compartment of it is room for the cold fluid, led via several radial cooling fluid channel 17 from its end of evaporator 7 where the cooling fluid inward of lower G and lower pressure is cooled on its way into its room in SMR heat exchanger 20 for the cold fluid that collects heat through the heat exchanger tube from the syngas outside. Inside of the SMR heat exchanger 20, there may be an insulating tube that forms the outer periphery of WGS 9 and forms the space for it with a heat exchanger tube within that transport heat inward from WGS 9, where all the Syngas and extra water vapor comes from multiple radial SMR syngas channels 18 from its axial syngas channel in the SMR heat exchanger 20's one end and into WGS 9's one end, where the fluid is axially converted through it with adapted catalysts to more H₂ and CO₂ which, together with other syngas and extra water vapor, are transported from its other end's inner periphery tube, inward into several radial WGS syngas channels 19 or holes inward to SEP 10 consisting of a series of heat exchangers composed of several axial tubes with space within each other inward towards the rotation axis where every second space is for the products and the others for the cooling fluid that must be within it as it collects heat inward from the product's heat exchanger space, where it condenses first out extra water that is discharged liquid into the return water channel 26, then immediately CO₂ will condense and after further cooling before being delivered out liquid, pressurized and cold into CO₂ outlet channel 27 and finally the cold, pressurized and pure H₂ gas out to H₂ outlet channel 28. There may be several similar heat exchangers as mentioned and installed radially inside of SMR 8 and WGS 9 that heating water and Hydrocarbon on their way outwards to evaporator 7 and/or these heat exchangers heat cold fluid on the way inward and/or after first being directed from evaporator 7 directly into separator 10 for the lowest temperature there and then outwards again to one or more heat exchangers to collect heat during transport and inward to HP 11 which is supported by a tube that can also be with stators on the inside adapted to an axial compressor rotor if used. Or a cylindrical tube and at least one centrifugal compressor and shovel diffusor outside which in its periphery is connected to the heating fluid channels 25.

The aforementioned axial tubes around the axis of rotation are supported and sealed with means on the ends towards discs (not shown) which are further centered and supported by the rotating device 2 and where all channels are sealed and fixed with means against each other. These discs can have axial channels through the discs and radial channels inside them or between them, for transporting all fluid inside the rotation device via their axial tube channels and connected to all inlets and outlets, with seals and fasteners against all channel's attachment points outward/inward.

The heat pump HP 11 is in practice located closer to the axis of rotation than shown in the principle fig and contains a compressor (not shown) that can be of the axial and/or centrifugal type with its shaft laid centered along the rotating device's 2 axis of rotation 1 and connected to an EL 24 motor (not shown) for rotation and it can be balanced and adapted inside the rotating device 2 centered around the axis of rotation 1 (not shown) encapsuled in the circuit of the HP 11 with insulated wires to its slip rings insulated on the outside outlet shaft 5, with contact to its respective static brushes for EL 24 supply and a separate motor (not shown) is connected to one of the shafts 3, 5 for custom rotation of the rotary device 2. Or an Electric EL 24 motor (not shown) axially outside the rotating device's 2 single shafts 3, 5 is connected to the HP 11 compressor via a magnetic coupling for hermetic sealing of its gas, where the electric motor provides rotation both to the compressor and the rotating device 2 by allowing the kinetics of the HP fluid from compressor against stators and/or diffusers attached to the rotating device 2 that provide a customized desired rotational force to it. On the other hand, HP 11 can also be placed outside the rotor with cooling fluid inlet/outlet 23 channel, or a smaller HP inside and a larger one outside the rotor and that their cooling fluid inlet/outlet 23 channels are connected.

The purpose of the special HP 11 is to create heat and cold, this is done using a heavy gas that is not consumed and has a low heat capacity (Cp) and can be xenon or a custom gaseous mixture gas and pressurized throughout the hermetically closed HP 11 circuit also during operation and the fluid is referred to as heating fluid on the way outwards and cold fluid on the way inwards and all the way to the compressor in HP 11. Since dominant heat production in the HP circuit occurs after compressor after which and inside the branched radial heat fluid channels 25 of the heavy fluid gas being compressed by the high centrifugal force (G) and forming more and more heat outward which is eventually emitted indirectly from the periphery in the adapted amount inward to both evaporator 7 and SMR 8 in order to carry out the process. It is equal to absolute delta temperature (ΔT=(v²−v₀²)/2Cₚ in the heat fluid's heat fluid channels 25 outward and inward in its cooling fluid channel 17, 20, 21, 22, 23 back to HP 11 and where its fluid is turned into a cooling fluid on its way inward again through its cooling fluid channels from evaporator 7. After heat is emitted at the periphery until evaporator 7 and is directed inwards into its cooling fluid channel 17, 21, and immediately becomes much colder than the other products at equal radius. Thus, the cold fluid receives significant return heat inward. The more heat received further out towards the periphery, as in the case of SMR heat exchanger 20, it will provide both less cold at the center, as to separator 10 and this also provides less necessary compression work on the heating fluid in HP 11 to be able to drive the colder cooling fluid with higher G inward again. But the cooling fluid can also first be directed directly into several radial channels, which branch inward (not shown) to separator 10 for the lowest possible temperature of the cooling fluid and provide the best separation there before the heat fluid is directed outwards to SMR heat exchanger 20, for receiving heat from the products there, or the cooling fluid is directed from SEP 10 and via SEP cooling channel 22 directly to HP 11 or first outside the rotor via cooling fluid outlet 23 channel and collects heat indirectly from the environment and then into HP 11 via its cooling fluid inlet 23 channel, where each channel is shown with a common arrow out/in in the principal FIGURE. An adapted cooling of the syngas in the SMR heat exchanger 20 and/or a similar heat exchanger within WGS 9 can instead be done with the water and HC heading outward in radial water channel 14 and radial HC channel 15, which evaporates before the evaporator 7. And the aforementioned HP 11 circuit from evaporator 7 all the way to SEP 10 and then outwards again to SMR heat exchanger requires higher compression work in HP 11, but this energy is nevertheless lower than the endothermic energy that SMR 8 requires by constant rotation of the rotating device 2 which will have equal rotational resistance if all fluids move outward and inward than if the fluids are not moving, i.e. as if it is a massive rotor with or without fluid movement. The cooling channel of the HP 11 from the periphery can also be laid via a heat exchanger (not shown) within the exothermic/heat-producing WGS 9 and in indirect contact with it and the gases out of it that is cooled indirectly by the cooling fluid in the heat exchanger and that the cooling fluid is led in channel to separator 10 or directly to HP 11. For cooling circuit with cooling fluid outlet/inlet 23 channels of the rotor to collect heat indirectly from the ambient with the inlet channel, the cooling fluid can be the same gas and be connected directly to channels in the inner circuit of the rotor, or it can be a separate circuit with its own fluid which can be an antifreeze that emits heat via a heat exchanger to inner circuit cooling fluid via a heat exchanger before HP 11's compressor.

The rotating device 2 may contain more heat pumps than the showed HP 11, with its own hermetically closed and high pressure circuits and the heat pumps may be magnetically connected together for rotation and hermetic sealing between them, or at least one HP is connected to the other's shaft with equal direction of rotation or be contra-rotating, where at least one of the other heat pumps has higher rotational force to drive custom rotation of the rotating device 2 as mentioned. For example, a HP circuit can make H₂ liquid at exit (not shown) by having at least one of the other heat pumps in front/pre-cool H₂ and that only cold H₂ is left at the bottom of SEP 10 and that another HP circuit contains its own pressurized gas as cooling fluid which can be argon, neon or helium or a custom gas mixture with an adapted pressure and amount led in channels, similar to described for HP 11 and to a separate HC evaporator outside said evaporator 7 with the same function as this and the heating fluid gas is directed to its one end to its outmost heat fluid chamber and that from the HC inlet channel 12 a cold liquid that can be liquid cold Methane/LNG is led in dedicated channels into the HC evaporator 7's other end into its inner HC chamber which with supplied heat via the heat exchanger tube at its periphery and evaporates the liquid Methane to gas with a countercurrent indirect heat exchanger with the heat from the heat fluid outside. The evaporated Methane gas is led from the HC evaporator into channels inwards for any further heating before being directed into its second evaporator 7 for more heat along with water/water-vapor as mentioned earlier. The cooling fluid from the outlet of the HC evaporator can then be as cold as the liquid Methane in. Cooling fluid temperature drops further as it is directed in channels inward as mentioned earlier into the separator's innermost part around axis of rotation 1 where the radial cooling fluid channels are connected to one of the closed ends into a centered axial cooling tube that forms the cooling fluid heat exchanger that is filled with the very cold cooling fluid, which can make it even colder via at least one pressure drop throttles at its inlet or with more through its heat exchanger channel where the cooling fluid receives heat towards outlet in the other end. On the outside of the cooling fluid heat exchanger tube, there is arranged and centered a new tube that is closed at the ends forming a space similar to what described earlier where cold H₂ under high pressure is led in before first separator 10, from its channels which are at opposite axial ends of inlet to neon, to form a countercurrent heat exchanger, where H₂ emits heat to the cooling fluid within which has an adapted temperature and pressure that is lower than critical temperature to H₂ with high pressure and is adapted for H₂ to become liquid. The H₂ cooling cylinder contains nickel catalysts to convert H₂ from ortho-H₂ to para-H₂ condition before being directed to its H₂ outlet channel 28. Refrigerant fluid from the cooling heat exchanger can be directed to further heat capture/cooling in and/or from outside the rotor as mentioned earlier before the cooling fluid is directed to its compressor in its HP circuit and new cycle outward towards the periphery. The rotating device 2 can thus be relatively cold on the outside and in addition to obtaining heat from the process, products and the environment outside the rotor, this will utilize low-temperature heat and therefore provide a device with very high efficiency.

The rotating device 2 can also operate at a lower rpm and the compressor(s) in the heat pump(s) do the dominant compression and heat production and there is at least one adapted throttle at the inlet of the axial heat exchangers inwards each of which can contain several throttlers that provide an adapted lower temperature of the cooling fluid as it moves inward and can also be adapted to condense axially and then evaporate by capture heat as mentioned, before the cooling fluid eventually returns to its compressor(s).

The inlet fluids in channels 12, 13 and return water channels 26 can also be led in radial channels 14, 15 via heat exchangers within WGS 9 and/or SMR 8 and/or HP 11 circuit there that give heat to them which may be sufficient for water to be liquid in water channels 13, 26, 14 and Hydrocarbon channels 12, 15 if it is also liquid and that they evaporate before they reach evaporator 7 which will then heat them further to the desired temperature. As liquid provides the highest compression, evaporation on a lower radius will give lower pressure into evaporator 7 and further inward from it. This can be adapted by a water trap channel (not shown) first directing the steam inward to the adapted radius before being led into evaporator 7. If both inlet fluids in channels 12, 13 are liquid and at equal temperature, they can have a common inlet which can be water inlet channel 13 where they are mixed with return water from the return water channel 26 before they are all collectively diverted in several radial water channels 14 outwards as described earlier. With this solution, HC inlet channel 12 can be omitted or used for other purposes, such as cooling fluid inlet 23 channel which collects heat from the environment via an external heat exchanger and is diverted with means to its circuit and the cooling fluid outlet 23 of the cold fluid is there as shown in the FIGURE.

It can also be arranged in the center at least one steam turbine (not shown) connected to one or more heat pumps at the center via a magnetic coupling, where hot Syngas with extra water steam from SMR 8 is first directed directly to the inlet of the steam turbine, which provides rotational force, which reduces the equivalent of EL 24—power supplied to the heat pump(s) EL motor(s). The syngas with extra water vapor is led after the steam turbine further in channels beyond again to SMR syngas channels 18 by adapted low pressure drop through the turbine or by an adapted higher pressure drop through the turbine and then via an axial heat exchanger radially outside WGS 9 where the fluids with means mentioned receives adapted heat that can be in the cooling fluid in the SMR heat exchanger 20 and that as previously mentioned they change places where the warmer cooling fluid is at the outermost and Syngas from the steam turbine with extra water vapor is at the bottom and after adapted heating it is led in to WGS 9 via WGS Syngas channels 19 mentioned earlier. The pressure after the steam turbine must be adapted so that it is not so low that the gases and water vapor reach a pressure in SEP 10 which is lower than critical pressure for them compared to the cooling fluid at temperature in SEP 10 in order to condense out each fluid. The syngas and additional water vapor can also be supplied from WGS syngas channel 19 to said steam turbine, where the fluids are then directed at a custom pressure to SEP 10 for further condensation as mentioned. There may also be at least one custom turbine in the center of each cooling fluid to utilize for work for a custom expansion for a lower temperature to SEP 10.

WGS 9 consists of a low-(LT) and high-temperature (HT) range, with catalysts adapted for each area.

So far, WGS 9 is mentioned located radially inside of SMR 8, but WGS 9 can also be placed at the periphery of the rotating device 2 and axial longitudinal next to one of the ends of evaporator 7 and SMR 8 and the inner radius can advantageously be similar as SMR 8. Thus, WGS 9 can become axially shorter and operate in higher G which is beneficial, and it can be made smaller but with the same capacity as before at the inner radius. Inlets/outlets to/from WGS 9 and heat exchanges may be similar as described earlier.

The rotating device 2 is enclosed in a cylindrical protective housing (not shown), which in the center at each end supports inlet bearing 4 and outlet bearing 6 where dynamic seals can also be installed between the protective housing and shaft 3, 5 (not shown), which can advantageously be on either side of each bearing 4, 6 which can be radial bearings, axial bearings with balls or plain bearings adapted with means of lubrication and temperature balance. The inner side of the protective casing can have a channel out and means to form low pressure/vacuum that reduces rotational resistance, noise and heat loss from the rotary device 2. The protective housing may be placed horizontally or vertically at an anchored part with connecting means at said inlet and outlet. Attached to one end of centered protective casing is the motor for the HP 11 compressor and/or for rotation of the rotating device 2 and optionally brushes whose compressor motor is inside its HP 11 circuit.

Custom gland boxes (not shown) are connected around each inlet channel 12, 13, 23 and each outlet channel 27, 28, 23, where static part in the gland box is with means attached and centered to the protective casing. Gland box can be of the type cartridge sealing with custom fastening, sliding surface for high revs, temperature, pressure, fluid in/out where the sliding surface can be of carbide.

SMR 8 can be filled and arranged with several thin catalytic discs (not shown) perpendicular to the axis of rotation 1 laid out towards and around the entire inner and outer periphery inside SMR 8. The discs are thin and can have radially backward-bent small shovels and a porous catalytic surface structure on the entire side, where all shovels can be backward bent in the direction of rotation, or every second disc is so and every second disc between them has forward bent shovels on each side. The shovels will then, when pressed together, cross each other, and lie on top of each other axially. This forms both an adapted space between them and provides better turbulence in addition to high G which provides further mixing from the density change as the fluids move along the discs and shovels outwards/inwards and it provides better contact with catalysts and increase conversion that can go very fast without cooling down too much, due to heat carrying in the extra water vapor and heat from evaporator 7 over the periphery that transfers extra heat inwards via both the discs and the gas in the SMR. The self-supporting disc core is of a material that resists temperature, oxidation, and the forces in the SMR during rotation and operation. The discs' surfaces are coated with one or more catalysts, and they are centered in contact with the inner and outer periphery of SMR 8 for heat transfer through the discs from the periphery and otherwise inside SMR 8. Each disc has several holes or semicircle grooves evenly located along the inner and outer periphery, which in the assembled position form axial channels at the inner and outer periphery of SMR 8. It may also be that some of the discs do not have these holes or grooves long either inner or outer periphery, from where the inlets of the fluids at the periphery of SMR 8's one end and after a custom number of discs, the disc does not have holes/grooves out at its periphery and blocks the axial channel along the periphery, so that the fluid must flow inward between the other discs and along the inner periphery channels. After an equal number of discs from the disc that closed the outer periphery canal to a disc without holes/grooves at its inner periphery. This forces the fluids outward again and similarly continues inwards and outwards a number of times further through SMR 8 until its outlet as described earlier for the fluids at its inner periphery at the other end. WGS 9 and H₂ liquefaction chambers can be built up in the same way with their custom catalyst discs.

As there are large temperature variations inside the rotation device 2, and for the sake of the expansion of the materials by temperature increase and contraction at low temperatures, the adapted radial and axial expansion zones arranged that can capture this movement without excessive stresses while keeping tight and provides an adapted bracing to hold the parts of the rotating device 2 in place to avoid imbalance and leakage. This can be done in favorable places (not shown) by all the aforementioned pipes/hollow cylinders having in whole or part of the length of the pipe, a waveform/corrugating completely transverse relative to the axis of rotation or having a shape that can resemble corrugating external and internal threads in the same place on the same position on the outer and inner sides that give equal pipe thickness on them and so that they get an axial adapted axial springy support. Similarly, it can also be arranged fully or partially radially on the discs that support the pipe ends. The aforementioned catalytic discs in SMR 8 and WGS 9 can be adapted to these and screwed into position with adapted holes/grooves at the inner and outer periphery to form axial channels, which will now follow the threads, or by transverse corrugation and threads, an inner and outer pipe is inserted where their outer side is laid against the interior peaks of the corrugation. The inner and outer pipes can advantageously be adapted with a series of holes that replace the catalytic discs' holes/grooves and adapted for the same function as mentioned, in that the holes in the inner/outer pipes are adapted to lead both in and out from each corrugation.

The rotation device 2's end caps that attach and seal to its outer tube and with each axis 3, 5 in the center, the end caps can advantageously be spherical with the shape of a hollow hemisphere/globular cap where the wall can be equally thick radially outward, and which faces axially outward at each end. This provides greater radial and axial flexibility, as well as reducing material use to achieve the desired strength. The previously described discs can also have a similar shape (not shown) that supports all pipes at the end and then each hemisphere can be attached and sealed axially to separate tubes at each end. The space between each hemisphere inside with external shovels laid out in balance and centered towards the inner side of the hemisphere outside and can form channels for fluid outward/inward completely or partly outward/inward, where then the different fluids can share the same channel, but that the channels are sealed against the other fluids in a radius where they are directed with means in separate channels in/out to/from reactors or heat exchangers inside the rotation device 2. The end caps can also have a shape such that they first curve axially outward from the periphery and at a radius arc axially fully or partially inward again, where the shafts 3, 5 at attachment to the end caps in the center then become axially closer to each other's ends. The protective housing will have the same shape inside as the rotating device 2 has externally and with adapted clearance between them.

The channels of the rotary device from inlet to outlet might, with means, be heat insulated to and from all heat exchangers and all rotating parts 7, 8, 9, 10, 11.

The rotating device 2 must have the necessary materials to withstand the forces of high rotation, high pressure, high and low temperature and chemical reactions so that strength is maintained during rotation and the process.

Heat exchangers must have a material with good thermal conductivity and strength in relation to the temperature and pressure at which they will operate.

The rotation device can be aligned with self-balancing agents, which can be at least one enveloping channel at the periphery where a liquid partially fills the canal.

The rotating device 2 has so far been described in several parts that are assembled with fasteners, sealants, insulators and catalysts. But the entire rotor or parts of it can also be 3D printed and where each medium and consistency is built up in layers axially to form a complete balanced tight rotor with channels, which are simultaneously joined.

Mentioned catalysts in SMR 8 and WGS 9 can be in any form with or without oxide or in combination of: platinum, nickel, iridium, cobalt, iron, yttrium, zirconium, strontium, lanthanum, manganese, copper, zinc, aluminum or materials with similar properties.

FIG. 1 is a principle drawing and does not show the real design of the device.

### REFERENCE NUMBERS TO RELEVANT COMPONENTS WITH COMMENTS

1. Axis of rotation
2. The rotating device, including below:
3. Inlet shaft, hollow.
4. Inlet bearing.
5. Outlet shaft, hollow.
6. Outlet bearing.
7. Evaporator.
8. SMR (Steam Methane Reformer) reactor.
9. WGS (Water Gas Shift) reactor.
10. SEP (separator), condensation separator containing a series of axial heat exchangers, where heat is drawn from the products over to the cooling fluid that has a lower radius than the hotter products of SEP.
11. HP (Heat Pump), containing compressor.
12. HC inlet channel (HC=Hydrocarbon), axial pipe.
13. Water inlet channel, for process water in the space inside an axial pipe around HC inlet channel 12.
14. Radial water channels, branching from center water inlet channel 13, 26 outwards to evaporator 7
15. Radial HC channels, branching out from center HC inlet channel 12 outward to evaporator 7.
16. Compression, symbols on all arrows/fluid outwards of increasing centrifugal force where gas becomes hotter.
17. Cooling fluid channels from evaporator 7, with decompression symbol, equal for all arrows/fluids inward of decreasing centrifugal force and gas becomes colder.
18. SMR Syngas channels, branched inward from the end of the SMR heat exchanger 20 in to one end of WGS 9.
19. WGS Syngas Channels, from outlet of WGS 9 and branch inward into several channels into one end of SEP 10 at its periphery.
20. SMR heat exchanger, collects heat from SMR Syngas channel 18 from SMR 8.
21. Cooling fluid channels, radially that branch inward for cooling fluid from the end of the SMR heat exchanger 20 can inwardly receive heat from WGS 9, shown by arrow in/out.
22. SEP cooling channel, for cooling fluid from cooling fluid channels 21 into SEP 10 and from SEP10 to HP 11, shown by common arrows for each channel in/out of SEP 10 in FIG.
23. Cooling fluid outlet channel and cooling fluid inlet channel, collects ambient heat, shown in fig with a common arrow for each channel in/out.
24. EL, supplied electricity to electric motor to drive compressor in HP 11 and rotating device 2.
25. Heat fluid channels, from HP 11 compressor to periphery of evaporator 7 where the temperature increases more and more in the heating fluid outwards in the channels.
26. Return water channel, for condensed liquid water from SEP 10
27. CO₂ outlet channel, for condensed cold CO₂ from SEP 10
28. H₂ outlet channel, cold high pressure H₂ gas, or liquefied with several HPs 11.

1. A drive adapted to produce H₂ and CO₂ from supplied Hydrocarbon and water under high pressure,
means to rotate a rotation device with inlet for Hydrocarbon and inlet for water, and the outlet for liquid CO₂ and outlet for H₂, a hollow cylindrical evaporator supported inside and at the periphery of the rotary device, with the evaporator connected to the inlets of Hydrocarbon and water, and when the evaporator is aligned with a heat exchanger that receives a flowing heating fluid from a heat pump HP to indirectly heat and evaporate flowing Hydrocarbon and water,
a steam Methane Reform Reactor SMR connected to the evaporator and which is aligned with catalysts for the conversion of Hydrocarbon and water into an Syngas of H₂, CO and CO₂, which together with excess water vapor is led via SMR heat exchanger to a Water Gas Shift reactor WGS aligned with catalysts to convert CO and water into more H₂ and CO₂, and
a gas separator SEP associated with WGS and HP and which is arranged with several heat exchangers that condense out first liquid return water, then liquid CO₂ which is led pressurized in the CO₂ outlet channel and finally the residual product H₂, cold pressurized gas that is led in the H₂ outlet channel.

2. The drive according to claim 1, where heat transfers from a warmer fluid to a colder fluid, inside the rotation device 24 are arranged in the suitable place, with several custom axial heat exchangers centered around the axis of rotation, each of which is with two hollow cylindrical axial chambers delimited by an inner and outer tube with axial heat exchanger tubes between them and they are sealed and supported at the tube ends, where the warmest fluid is discharged into channel at an axial end of the outermost hollow cylindrical chamber and discharged into channel at the other end, and the coldest fluid is diverted in channel into the innermost hollow cylindrical chamber and on axially opposite end of warmest fluid inlet, where the coldest fluid receives heat from the hottest fluid outside via the heat exchanger tube in a countercurrent heat exchange, before the heated fluid is directed to outlet at the axially other end and if a warmer source is outside the outer chamber of the cooled fluid, the heat can be insulated with a heat-insulating tube of the outer side of the outermost tube of the heat exchanger.

3. The drive according to claim 1, where Hydrocarbon and water from said inlet on their way outwards to evaporator, receiver heat via axial heat exchangers and evaporate with heat from the inner radius of WGS and/or SMR and/or from an axial WGS Syngas channel and/or from an axial SMR syngas channel and/or from a heat exchanger with cooling fluid from cooling fluid channels in the outermost heat exchanger channel when it is warmer than the inlet fluids, where from the heat exchanger where the inlet fluids evaporate, it is first directed in channels inward to a favorable radius, before the channels are directed outward to any further heating or directly to the evaporator for final adapted heating before the inlet fluids are directed in to the SMR.

4. The drive according to claim 1, where said HP 14 is furnished with several heat pumps with their own circuits and gases adapted for heating and cooling in a favorable place inside and outside the rotation device, where a first circuit HP may contain xenon or a mixed gas under high pressure and another heat pump circuit can be adapted for liquefaction of Hydrogen, in that a gas under high pressure in the circuit that can be one of argon, neon, helium or an adapted gas mixture that is compressed and directed outwards to a countercurrent heat exchanger at the periphery as a countercurrent heat exchanger indirectly to a liquid HP, which can be Methane/LNG from the HC inlet channels which evaporates and can be directed inward for further heating before being directed to its evaporator and the cooling fluid may have the same temperature out of the heat exchanger as liquid HC had into it and its cooling fluid is led with further temperature drops in channels inward to a new countercurrent heat exchanger at axis of rotation 1 where it collects heat from H₂ until it condenses under high pressure in its chamber outside, where nickel catalysts are arranged to convert from Orth-H₂ to Para-H₂ before being led liquid to the H₂ outlet channel.

5. The drive according to claim 1, where the rotation device's anchors with at least one SMR with catalysts, at least one WGS with catalysts and at least one HP with compressor, are arranged and supported between each axial inner and outer pipe laid centered around the axis of rotation which forms each of their hollow cylindrical spaces which may be within each other in the aforementioned order and are supported, attached and sealed in their tubes ends with centered and supporting discs supported by the rotation device, where in the supporting discs there are arranged channels for fluid in/out to/from each hollow cylindrical space.

6. The drive according to claim 1, where said SMR and WGS are filled and laid out with several thin discs of a self-supporting material and are laid out perpendicular to the axis of rotation towards and around the entire inner and outer periphery inside the SMR and WGS, where the discs can be thin and can have small radially backward-bent shovels, where the discs e are applied to an adapted porous catalytic surface structure on each side and where all shovels can be backward bent in the direction of rotation, or every other disc there is and every other disc between them has forward-bent shovels on each side, where each disc can have several holes or semicircle grooves evenly located along the inner and outer periphery, which in the juxtaposed position form axial channels at the inner and outer periphery of the SMR and WGS, where some of the discs do not have these holes or grooves long either inner or outer periphery, where from the inlets of the fluids at the periphery of the SMR and WGS at one end and after an adapted number of discs, this disc does not have holes/grooves at its periphery and blocks the axial channel along the periphery, so that the fluid must flow inward between the other discs and along the internal axial periphery channels, where there are an equal number of discs after the disc that closed the outer periphery channel to a disc without holes/grooves at its inner periphery, thus forcing the fluids outward again and continuing in the same way inwards and outwards a number of times further through the SMR and WGS until their outlet at the inner periphery at the other end.

7. The drive according to claim 1, where said HP is constructed at and around the axis of rotation and contains at least one compressor that may be of the axial and/or centrifugal type with its shaft laid centered longitudinal rotation device's axis of rotation and connected to an EL motor for rotation and it can be balanced and arranged inside the rotating device encased in the circuit of the HP with wires to its slip rings insulated on the outside of the outlet shaft, with contact to its respective static brushes for EL supply and a separate motor connected to one of the shafts for custom rotation of the rotary device, or an electric EL motor axially outside the rotary device's single shafts centered and attached to the protective housing and connected to the HP's compressor via a magnetic coupling for hermetic sealing of its gas, where the electric EL motor can be adapted to provide rotation to both the compressor and the rotary device by allowing the kinetics of the HP fluid from the compressor against stators and/or diffusers attached to the rotary device to simultaneously provide a customized rpm of the rotary device and at several heat pumps they can be connected by magnetic couplings and a common motor.

8. The drive according to claim 1, where said Syngas with additional water vapor is led in heat-insulated channels directly from SMR or WGS inward into channels to at least one steam turbine at the axis of rotation connected by magnetic coupling to at least one HP to reduce the rotational force of the EL motor and adapted so that the compressor work in the HP is constant with or without the steam turbine.

9. The drive according to claim 1, where said catalysts in SMR 8 and WGS may be in any form with or without oxide or in combination of: platinum, nickel, iridium, cobalt, iron, yttrium, zirconium, strontium, lanthanum, manganese, copper, zinc, aluminum, or materials with similar properties.

10. The drive according to claim 1, where said channels from inlet to outlet are heat insulated to and from all heat exchangers.

11. The drive according to claim 1, in which the transfer of fluids occurs via axial pipes is corrugating in all or part of its length.

12. The drive according to claim 11, where the washers supporting the axial tubes are corrugating in all or part of their radius.

13. The drive according to claim 12, where said discs and end caps supporting the rotating device and the axial tubes have an axial hollow hemispherical/globular cap, beyond the facing shape, with external shovels on the inner hemispheres adjacent to the hemispheres outside to form the channels of the device.

14. The drive according to claim 1, where said rotation device is aligned with self-balancing agents, which may be at least one enveloping channel at the periphery where a liquid partially fills the canal.
